(19) United States
(12) Patent Application Publication
(10) Pub. No.: US 2026/0048297 A1
(43) Pub. Date: Feb. 19, 2026

(54) VIRTUAL WORKOUT INSTRUCTION WITH USER-VARIABLE CHARACTERISTICS

(71) Applicant: Michael S. Moore, Portland, OR (US)

(72) Inventor: Michael S. Moore, Portland, OR (US)

(21) Appl. No.: 18/806,041

(22) Filed: Aug. 15, 2024

(51) Int. Cl. A63B 24/00; A63B 71/06

(52) U.S. Cl. CPC A63B 24/0075; A63B 71/0622; A63B 2071/063

(57) ABSTRACT

Embodiments herein relate to a workout system configured to generate, based on a user selection of a pre-configured workout routine and a user selection of characteristic of prompts provided by a virtual instructor of the workout routine, one or more prompts. The one or more prompts may include a motivational and/or instructional prompt. The prompt may then be provided to the user during execution of the workout routine. Other embodiments may be described and claimed.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Workout applications (which may also be referred to herein as “apps”) may be a useful part of an individual's exercise plan and exercise goals. Generally, a workout app may provide an interface by which a user is able to access one or more of several available workout routines. Each one of the workout routines may have a variety of different exercises or sequences of exercises that are presented to a user in a given sequence. The workout apps may include audio and/or video components by which an instructor (who may also be referred to as a “Coach”) provides direction to a user. Typically, the instructor may often provide encouragement to a user of the workout app in an effort to assist the user with motivation and energy during their workout routine.

### BRIEF DESCRIPTION OF THE FIGURES

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 depicts an example of a system that may be associated with the use of a workout app, in accordance with various embodiments.

FIG. 2 depicts an example data structure for a plurality of workout routines, in accordance with various embodiments.

FIG. 3 depicts an example of a user interface, in accordance with various embodiments herein.

FIG. 4 depicts an example of elements of a user interface, in accordance with various embodiments.

FIG. 5 depicts an alternative example of elements of a user interface, in accordance with various embodiments.

FIG. 6 depicts an alternative example of elements of a user interface, in accordance with various embodiments.

FIG. 7 depicts an example of different user experiences with a virtual instructor, in accordance with various embodiments.

FIG. 8 depicts an example system which may be used to implement a workout app, in accordance with various embodiments.

FIG. 9 depicts an example of a process flow related to implementation of a virtual instructor and/or a workout app, in accordance with various embodiments.

### DETAILED DESCRIPTION

As previously noted, workout apps may be a useful part of an individual's exercise plan and exercise goals. Generally, a workout app may provide an interface by which a user is able to access one or more of several available workout routines. As an example, the workout routines may relate to a specific exercise type such as cycling, rowing, weightlifting, running, bodyweight exercises, yoga, meditation, swimming, and/or some other exercise type. Some apps may be dedicated to a single exercise type (e.g., a “running” app, a “cycling” app, etc.). Other apps may be dedicated to a plurality of exercise types. As one example, the Peloton™ app associated with Peloton Interactive, Inc. is one well known workout app that provides a user with a variety of workout routines related to cycling, running, yoga, meditation, and bodyweight exercise types.

In addition to providing workout routines related to different exercise types, a given workout app may have a variety of different workout routines within a given exercise type. For example, an exercise type may have workout routines of differing lengths. Additionally or alternatively, some workout apps may have a variety of workout routines within a given exercise types that relate to different routine structures. As used herein, “routine structures” may describe different goals or styles of workout routines such as high intensity interval training (HIIT) workout routines, workout routines related to building endurance, low-intensity “recovery” workout routines, workout routines related to weight loss (e.g., “fat burning” aerobic) workout routines, and/or other types of workout routines.

Typically, each workout routine may be generated, and lead, by an exercise instructor. The instructor may be an exercise professional that is able to generate a given exercise routine. For example, a give exercise routine may include a sequence of specific exercises or stages of exercises, which are selected by the instructor for the purpose of achieving a specific goal for the workout routine as described above (e.g., recovery, HIIT, endurance, aerobic, etc.).

In addition to generating the workout routine, the instructor may further provide prompts to the user as the workout routine progresses. For example, a given routine may include a sequence of specific exercises or stages of exercises, and an instructor may provide instruction to the user regarding the different exercises prior to their occurrence and/or as they occur. For example, an instructor may say “In 30 seconds, we switch to this exercise.” During the exercise, the instructor may provide functional instruction to the user regarding form, reminders regarding parameters or characteristics of the current exercise and/or stage of the workout routine such as intensity, number of repetitions, and/or other instruction. Such information is referred to herein as “instructional prompts.”

In addition to the generation of the routine and the provision of the instruction to the user, the instructor may provide additional comments or prompts as the routine progresses. Such comments may be non-functional in nature, and may be related to motivation or encouragement of the user. Simplistic examples of such motivational comments may be comments such as “you've got this,” “almost there,” “don't quit now,” and/or other similar comments. Such non-functional prompts are referred to herein as “motivational prompts.”

In general, and for the sake of clarity, the term “prompts” herein will be used herein to refer to commentary from an instructor and/or virtual instructor. The prompts may include one or both of instructional prompts and motivational prompts.

Finally, in addition to generation of the workout routine and provision of prompts, the instructor may pick a specific theme or tone for a given workout routine. The theme or tone may be provided through the specific word choices used by the instructor, the music chosen to accompany the workout routine, and/or some other characteristic of the workout routine.

However, the above-described tasks of an instructor may, in some cases, be undesirable. For example, a user may want a specific workout routine, but may not want to hear from an instructor as often. A user may prefer a different tone or level of enthusiasm/motivation to be provided by the instructor during the workout routine. To put it another way, a user may want a specific workout routine, but may find the presentation of that routine by the instructor to be undesirable. In some instances, a user may wish to hear from an instructor of a given gender, an instructor with a given accent, and/or some other type of characteristic.

Embodiments herein resolve one or more of the undesirable aspects that a user may experience during their interaction with an instructor. Specifically, embodiments herein relate to a workout app with a user-variable virtual instructor. In some embodiments, a user may be able to select one of a variety of different pre-defined workout routines. The user may then be able to change one or more characteristics of the virtual instructor so that the user may customize the user's experience throughout the workout routine. Some example characteristics may include characteristics of the instructor themselves such as the instructor's age, accent, gender, etc. Other characteristics may include characteristics related to prompts provided by the virtual instructor such as the instructor's positivity, attitude, enthusiasm, and/or other characteristics.

Based on the user-selected characteristics, the prompts, and particularly the motivational prompts, provided by the virtual instructor may be tailored to the preferences of a user. In this way, different users (or the same user repeating a given workout routine) may be able to perform the exercises of a given pre-configured workout routine and have significantly different experiences than one another.

Embodiments herein may provide a variety of benefits. For example, by being able to vary the presentation of instruction of a workout routine, a workout app may be able to cater to a wider range of users. In addition, rather than having to have different instructors with different personalities to fill different instruction/motivation styles, the instructors may be freed up to focus on generating new workout routines and content rather than finding themselves limited to workout routines that are most appropriate for their presentation style.

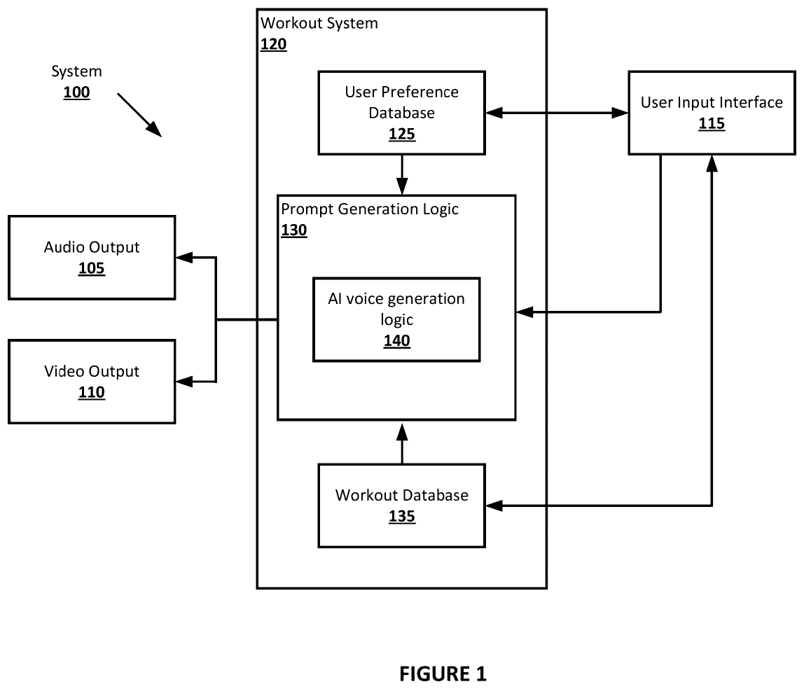

FIG. 1 depicts an example of a system 100 that may be associated with the use of a workout app, in accordance with various embodiments. The system 100 may include a workout system 120 that has a user preference database 125, prompt generation logic 130, and a workout database a.

The user preference database 125 may be configured to store information related to a user preference. In various embodiments, the user preference database 125 may be implemented as hardware, software, firmware, and/or some combination thereof. In some embodiments, the user preference database 125 may be implemented in some form of memory such as non-volatile memory (e.g., flash memory, random access memory (RAM), read-only memory (ROM), erasable programmable ROM (EPROM), dynamic RAM (DRAM), synchronous DRAM (SDRAM), and/or some other type of memory). The data of the user preference database 125 may be implemented as a table or some other data structure that may include, for example, an indication of a specific user preference regarding a virtual instructor such as a preference regarding instruction frequency, instructor attitude, instructor positivity, age, gender, accent, etc.

In some embodiments, the user preference database 125 may include information related to a specific user (e.g., a “user profile”) which includes an indicator of the user and one or more indicators of user preferences. Such user profile may be stored between user workout sessions so that the user's preferences can be identified by the workout system 120 without the user having to manually re-enter their preferences each time they selected a workout routine. In some embodiments, the user may be able to edit their user profile (e.g., change a single preference of a variety of preferences associated with the user profile). In some embodiments, the user may not be able to edit their user profile (e.g., the user may have to re-create a new profile to make a change to a preference). In some embodiments, the user preference database 125 may not store information related to a user profile that is re-usable between workout routines, and the user may be required to re-enter their preferences each time they wish to perform or participate in a workout routine.

In some embodiments, the user preference may be provided by a user input interface 115 that is communicatively coupled with the user preference database 125. The user input interface 115 may be, include, or be coupled with a variety of user input elements. For example, the user input interface 115 may be or include a graphical user interface (GUI). The user input interface 115 may be implemented as, or include, a touchscreen by which a user may make their selection. Broadly speaking, the user input interface 115 may be or include an interface by which a variety of information, options, and/or data is presented to a user such that the user is enabled to make a preference selection. In some embodiments, the user input interface 115 may be implemented as hardware, software, firmware, and/or some combination thereof. In other embodiments, the user input interface 115 may be implemented as a visual screen that is communicatively coupled with another input device such as a keyboard, a mouse, a stylus, and or some other input device. It will be noted that the above description of the user input interface 115 is given with respect to an interface by which information is visually presented to the user. In other embodiments, the user input interface 115 may additionally or alternatively include other interface elements that provide different modalities of information such as audio information (e.g., speakers or some other audio element), touch-based information (e.g., haptic feedback, dynamic braille presentation, or some other touch-based element).

In some embodiments, the workout system 120 may further include a workout database 135. The workout database 135 may be implemented as hardware, software, firmware, and or some combination thereof. Generally, the workout database 135 may store information regarding a variety of pre-configured workout routines as described above, and as described in greater detail below. Such pre-configured information may include information related to specific exercises or sequences of exercises within the workout routine, information related to different stages of exercises, information related to a total length of the workout routine, information related to points in time at which the workout routine is going to change, etc. In some embodiments, the workout routine may further include specific instructions related to a given exercise or stage of exercise such as instruction regarding how to perform the given exercise, information related to proper form to avoid injury, and/or some other information related to or used for provision of an instructional comment.

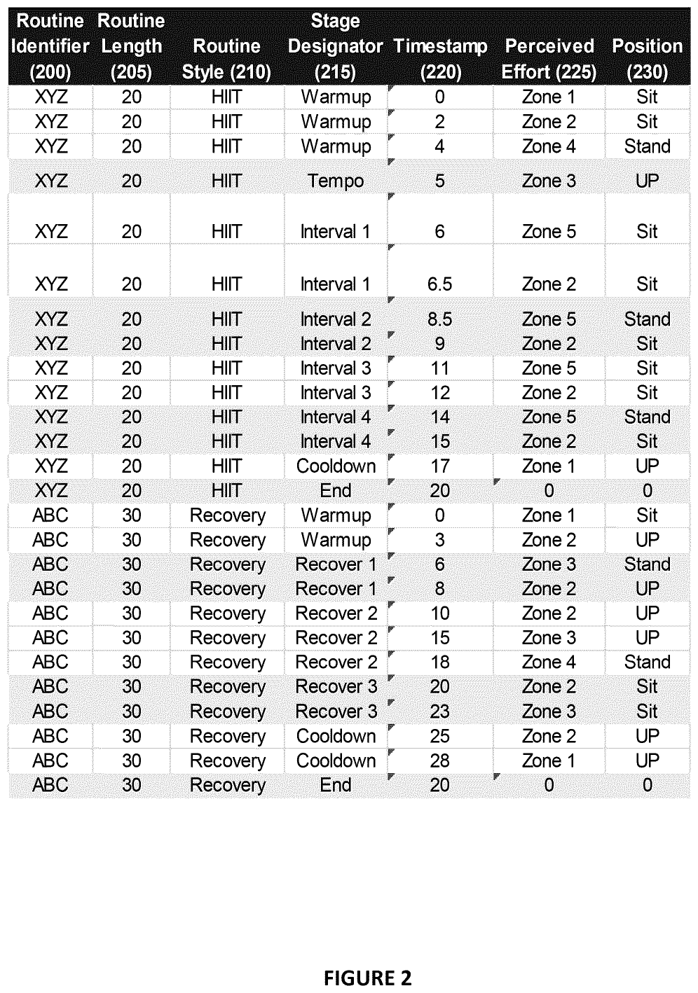

A workout routine may include a plurality of data points, as may be seen in FIG. 2. Generally, FIG. 2 depicts an example data structure for a plurality of workout routines, in accordance with various embodiments. It will be understood that the data structure depicted is intended as a very high-level overview of a data structure related to a 20 minute long HIIT cycling workout routine and a 30 minute long recovery cycling workout. The specific entries shown are shown in a human-readable format for the sake of discussion and example. Similarly, the shading provided in FIG. 2 is provided for the sake of facilitating human readability and understanding by depicting different stages within the workout routines. In real-world implementations, one or more of the various elements depicted in FIG. 2 may be implemented in some form of machine-readable code, hexadecimal or binary values, or some other implementation as will be known to one of skill in the art. In addition, it will be understood that the workout routines herein are provided solely for the sake of example and discussion, and may include one or more elements that may not correlate to a workout routine designed by a professional fitness coach or instructor. The depiction of a given workout routine is explicitly stated herein to not be intended to be followed unless under the supervision of, or in consultation with, a trained and qualified fitness and/or medical professional. Additionally, it will be understood that the depicted workout routines are depicted as related to cycling exercise type, and so data categories related to cycling such as “position” are used herein. Other workout routines related to other exercise types may have one or more additional or alternative data categories such as “repetitions,” “weight,” “heart rate,” “stroke,” “yoga position,” “form,” and/or some other data category.

As shown in FIG. 2, the data structure may include a variety of data categories such as routine identifier (200), routine length 205, routine style 210, stage designator 215, timestamp 220, perceived effort 225, and position 230.

As shown, the routine identifier 200 may provide a unique identifier of each of a plurality of workout routines in the workout database 135. For example, the identifier “XYZ” may be associated with a 20-minute long HIIT workout routine that has the depicted stages. Similarly, identifier “ABC” may be associated with a 30-minute recovery workout routine that has the depicted stages. Similarly, a different identifier may be used for a different 20-minute long HIIT workout routine or a 30-minute long recovery workout routine.

Routine length 205 may provide an indication of a length of the workout routine. For example, FIG. 2 depicts that the length of the workout routine with routine identifier “XYZ” is 20 minutes long, and the length of the workout routine with the routine identifier “ABC” is 30 minutes long. In FIG. 2, the value of routine length 205 is given in minutes, however it will be understood that in other embodiments the value of routine length 205 may be given in some other unit or increment such as seconds, hours, central processing unit (CPU) cycles, etc.

Routine style 210 may provide an indication of the style of the given workout routine. For example, FIG. 2 depicts that the style of the workout routine with routine identifier “XYZ” is HIIT, and the style of the workout routine with routine identifier “ABC” is Recovery.

Stage designator 215 may provide information regarding the name or purpose of a given stage within a workout routine. Similarly, the value of timestamp 220 may provide an indication of when a stage or portion of a stage begins or changes within a given workout routine. As an example, FIG. 2 depicts that workout routine XYZ includes a warmup stage that begins at minute 0 of the 20-minute workout. XYZ further includes a tempo stage that begins at minute 5. There are then four intervals (Interval 1, Interval 2, Interval 3, and Interval 4), followed by a cooldown at minute 17. Workout routine XYZ then ends at minute 20.

It may also be seen that there may be changes within a given stage. For example, Interval 1 of workout routine XYZ may include a first portion with given data category characteristics that begins at minute 6, and a second portion with different data category characteristics that begins at minute 6.5. As used herein, the term “data category characteristic” may refer to one or more of the depicted entries for the various data categories of the workout routine. Therefore, the first and second portions of Interval 1 of workout XYZ may include the same data category characteristics such as routine identifier 200, routine length 205, routine style 210, and stage designator 215. The first and second portions of Interval 1 of workout XYZ may include different data category characteristics such as timestamp 220, perceived effort 225, and position 230.

Perceived effort 225 may provide an indication of the intended user effort for a given interval. In the example of FIG. 2, the perceived effort is depicted in terms of the well-known Heart Rate Zones 1-5 scale where a Zone 1 effort is between approximately 40% and 50% of a user's maximum effort, and a Zone 5 effort is between approximately 85% and 100% of a user's maximum effort. It will be noted that different sources may provide these distinctions with differences, and the specific values assigned to a given Zone, as used herein, are only provided for the sake of discussion and distinction, rather than intended to be definitive. Other embodiments may depict the values for perceived effort 225 in accordance with a different scale or designator.

Position 230 may provide an indication of an intended cycling position of the user. For example, a seated cycling position may work different muscle groups or provide a different power output than a standing cycling position. As such, a workout routine may be designed with the intention that a user be in a given stage is in a specific position. Additionally or alternatively, in some embodiments the position 230 may be left to user preference (depicted in FIG. 2 as “UP”). As such, the user may be encouraged to use the cycling position that they prefer for a given stage, which may be based on elements such as user comfort, muscles that the user wishes to target, ease of peddling, whim, etc.

Returning to FIG. 1, in some embodiments, the workout database 135 may be communicatively coupled with the user input interface 115. For example, the user may be provided, via the user input interface 115, with options related to the pre-configured workout routines. In some embodiments, such information may be presented in a “branched tree” configuration wherein the user first selects the exercise type (e.g., running, cycling, swimming, etc.) The user may then be presented with options related to the length of the associated workout routine, options related to routine structures, and/or other options.

Similarly to the user preference database 125, in some embodiments the workout database may store information related to a given user's preferences such that the order of options presented to a given user may change from user to user. In other words, the user's preferences or selections related to the workout database 135 may be similar to or part of a user profile as previously described with respect to the user preference database 125. In some embodiments, the user preference database 125 may be separate from the workout database 135 (e.g., the user preference database 125 is implemented on a separate piece of hardware/software/firmware/memory/etc. than the workout database 135). In other embodiments, the user preference database 125 and the workout database 135 may be implemented at least partially as a same piece of hardware/software/firmware/memory/etc. as one another.

The workout system 120 may further include prompt generation logic 130. The prompt generation logic 130 may be implemented as hardware, software, firmware, and/or some combination thereof. In some embodiments, the prompt generation logic 130 may be or include one or more processors or some other type of logic or processing circuitry. For example, the prompt generation logic 130 may be, include, or be part of a processing unit such as a CPU, a single core processor, a multi-core processor, a core of a multi-core processor, a quantum processor, and/or some other type of processor.

Generally, the prompt generation logic 130 may be provided information regarding the user's preferences for a given workout routine. Such information may be based on, for example, the user's preferences provided via the user input interface 115 to the user preference database 125 and may include, for example, information related to a positivity level of a virtual instructor, a frequency of communication, accent, sex, age, etc. as described herein. The prompt generation logic 130 may further be provided information related to the user's selection of one or more options related to a given workout routine such as those described above related to the workout routine length, the exercise type, the routine structure, and/or some other option as described above with respect to the workout database 135.

In some embodiments, the prompt generation logic 130 may “pull” or “fetch” this information from one or both of the user preference database 125 and the workout database 135. For example, in some embodiments the user input interface 115 may be communicatively coupled with the prompt generation logic 130 as shown. As such, if the user may be presented with an option via the user input interface 115 that, when activated, instructs the prompt generation logic 130 to query one or both of the databases 125/135 for information regarding the user's selection(s) and/or preference(s).

In some embodiments, this information may be “pushed” to the prompt generation logic 130 by one or both of the databases 125/135. For example, if a user interacts with one or both of the databases 125/135, for example by providing an indication of a preference or selecting a parameter of a workout routine, then such database may use such an interaction as a trigger to provide the information to the prompt generation logic 130.

In some embodiments the prompt generation logic 130 may be, include, and/or implement an artificial intelligence (AI) voice generation logic 140. Specifically, although AI voice generation logic 140 is shown in FIG. 1 as a sublogic of the prompt generation logic 130, in other embodiments the logics 130/140 may be separate from one another, logic 130 may be a sub-element of logic 140, the logics 130/140 may be the same logic, etc. The AI voice generation logic 140 may be based on one or more of a variety of AI-related systems such as machine learning (ML), a ML model, deep learning, a neural network (NN), an artificial NN (ANN), and/or some other type of AI technology. At a high level, the AI voice generation logic 140 may be or include one or more systems or algorithms that is/are configured to take a variety of inputs such as the user-expressed preferences and generate a synthesized speech output based on the user's preferences.

To perform this task of voice generation, one or more of the above-described AI-related systems of the AI voice generation logic 140 may have been previously trained on data related to the various user preferences. For example, the AI voice generation logic 140 may include one or more systems that were trained using data corresponding to a range of different ages, levels of enthusiasm, tones, attitudes, levels of positivity, accents, gender identities, and/or some other user preference.

In addition to the above-described data sets, it may be understood that the AI voice generation logic 140 may further be trained on data related to a variety of different exercise types, workout routines, and/or routine structures. This training data may be used by the AI voice generation logic 140 to generate prompts that use the correct terms for a given workout routine.

It will be understood that the above description of the AI voice generation logic 140 is an overly simplified overview for the sake of discussion, and various embodiments may vary in one or more ways from those above. For example, in some embodiments the AI voice generation logic 140 may be trained on one or more additional or alternative sets of data or data sources. In some embodiments, the data sets may include data related to instruction from a real world instructor using different levels of tone or positivity. As one specific, a data set may include different instructional or motivational prompts related to the same workout routine. One set of the prompts may have an insulting or negative tone, while another set may have a positive tone. Other parameters may be used, or others of the parameters may similarly vary.

Based on the information provided to the prompt generation logic 130 and, more specifically, the AI voice generation logic 140, the logic 130 may generate elements related to prompts by a virtual instructor. Specifically, the logic 130 may generate one or more instructional and/or one or more motivational prompts that are based on elements of the workout routine and are based on the user preferences provided by the user preference database 125. In some embodiments, the logic 130 may generate all of the prompts for a given workout routine prior to providing the prompts to the user. In other embodiments, the logic 130 may only generate one prompt at a time, and provide the prompts to the user as they are generated. In some embodiments, the prompts may be generated according to some other grouping such as all prompts for a given stage, prompts generated on a best-effort schedule, a pre-determined plurality of prompts at a time, prompt generation based on priority (e.g., instructional prompts generated prior to the generation of motivational prompts), etc.

The prompt generation logic 130 may be coupled with one or both of an audio output 105 and a video output 110. The coupling to the audio output 105 may be a wired or wireless coupling. For example, the audio output 105 may take the form of speakers, earbuds, headphones, a port to connect a pair of headphones or external speaker, and/or some other type of audio output. Generally, the audio output 105 may be configured to provide the generated motivational and/or instructional prompts the user of the system 100.

In some embodiments, the prompt generation logic 130 may also be coupled with a video output 110. The video output 110 may be configured to show information related to the workout routine to the user. For example, in some embodiments the system 100 and, more particularly, the workout system 120 may be configured to generate an avatar or representation of the virtual instructor. The avatar may be humanoid, non-human (e.g., an animal), may be of similar quality to lifelike, may be “cartoonish,” and/or may have some other characteristics. In embodiments, the movements of the avatar, and particularly the mouth movements of the avatar, may be synchronized with the workout routine so that the avatar is performing similar movements and/or appears to be speaking the prompts to the user. This synchronization may be desirable for reasons such as assisting the user with understanding the proper form of an exercise, providing entertainment for the user, and/or providing virtual “companionship” for the user during performance of the workout routine. In other embodiments, the video output 110 may additionally/alternative show other video such as movies/television shows, act as an e-reader or internet browser, provide instruction additional information regarding the various exercises, stages, and/or prompts (e.g., close captioning or pictures of correct form), show metrics related to the performance of the workout routine such as estimated caloric burn, time remaining, time elapsed, distance traveled, etc.

Generally, it will be understood that the description of the system 100, provided above, is intended as an example of the system 100 in accordance with one embodiment. Other embodiments may have more or fewer elements, elements arranged or coupled in a different configuration than depicted, etc. For example, logic related to the video output 110 may be different from the logic related to the audio output 105.

In some elements, the system may be generally implemented in a single form factor such as a mobile telephone, a laptop computer, a tablet, etc. In other embodiments, one or more of the elements may be physically separate from, but communicatively coupled with other elements of the system 100. For example, if the audio output 105 takes the form of wireless earbuds, then the remainder of the system 100 may be implemented as a mobile telephone or some other device. In some embodiments, one or more of the elements of the system 100 may be physically remote from the location of the user. For example, the prompt generation logic 130 (or elements or portions thereof) may be “in the cloud” and implemented at a server farm or some other location. One or more other elements of the system 100 may be generally co-located with the user, and communicatively coupled with the remote logic via, for example, a cellular connection, a land-based connection, and/or some other type of connection. The specific configuration or location of various elements is may differ among various embodiments in other ways that will be readily understood to one of skill in the art.

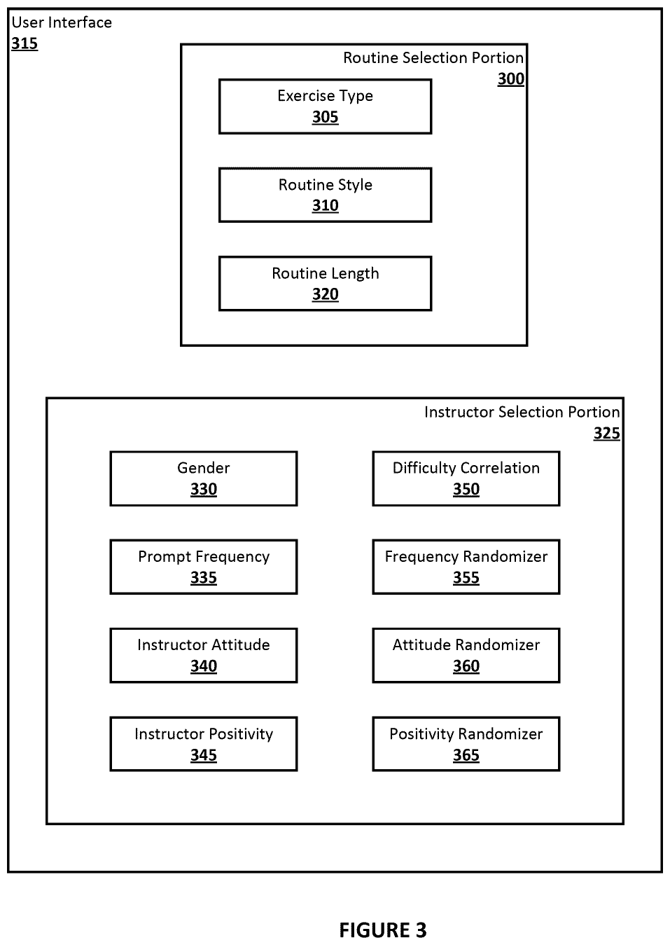

FIG. 3 depicts an example of a user interface 315, in accordance with various embodiments herein. The user interface 315 may be similar to, for example, user input interface 115. It will be understood that the depicted example is one non-limiting example of such a user interface and is depicted herein for the sake of discussion only. In other embodiments the user interface 315 may have a different configuration than depicted such that various elements are in a different location than depicted, elements other than those shown are additionally or alternatively present, etc. In some embodiments, various of the elements may have different names, elements may be combined, etc.

More generally, it will be understood that the user interface 315 may take a variety of different forms dependent on characteristics such as budget, aesthetic tastes, brand identity, etc., and the specific implementation of the user interface may vary in a variety of different embodiments. As such, the depiction and description herein is for the sake of providing one non-limiting example, rather than limiting the user interface 315 to a specific implementation or embodiment.

The user interface 315 may include a routine selection portion 300 and an instructor selection portion 325. In some embodiments, portion 300 may be displayed concurrently with portion 325, as shown in FIG. 3. In other embodiments, the two portions 300/325 may be displayed sequentially such that one of portions 300 and 325 are first displayed to a user and then, after a user provides their input, the other of portions 300/325 is displayed to the user. In some embodiments, portions 300 and 325 may be combined into a single portion that includes all of the various elements of the two portions 300/325. In some embodiments, an element of a portion 300/325 may be displayed prior to display of another element of the portion 300/325. For example, in some embodiments, only the exercise type element 305 may be displayed in the routine selection portion 300 and then, after a user provides their input regarding that element, a second element such as the routine style element 310 or the routine length element 320 may be displayed.

As may be seen in FIG. 3, the routine selection portion 300 may provide the user with a variety of options related to the workout routine. For example, the routine selection portion 300 may provide a user with an exercise type element 305. The exercise type element 305 may provide, for example, a user with the option to select from a variety of different exercise types such as swimming, yoga, running, cycling, and the like. In some embodiments, the exercise type element 305 may be implemented as a slider, a drop-down menu, or some other implementation. In some embodiments, selection of the exercise type element 305 may take the user to another screen of an interface where the different exercise types are displayed using icons, words, images, moving images, or the like.

The routine selection portion 300 may also include a routine style element 310. The routine style element 310 may allow the user to select a routine style that they prefer for their upcoming workout routine. For example, the user may be offered a variety of options such as HIIT, recovery, etc. In some embodiments, the routine style(s) offered to the user may be adjusted based on their exercise type selection, the availability of various workout routines, etc. Similarly to the exercise type element 305, the routine style element 310 may be implemented as a slider, a drop-down menu, a link to another page, and/or some other type of implementation.

The routine selection portion 300 may also include a routine length element 320. The routine length element 320 may allow a user to pick a length of their desired workout routine. Similarly to the routine style element 310, the options provided to the user may be dependent on factors such as the selected exercise type, the selected routine style, the workout routines available, etc. Additionally, the routine length element 320 may be implemented in one or more of the various implementation options described above, and/or some other implementation.

The instructor selection portion 325 may provide a user with a variety of options related to the virtual instructor and the prompts to be given by the instructor. It will be understood that the various elements shown in the instructor selection portion 325 are intended as non-limiting examples of such elements for the sake of discussing one specific embodiment. As previously noted, other embodiments may have more/fewer/different elements than depicted. Also, it will be understood that the various elements may be implemented in a variety of ways such as drop-down menus, slider bars, X-Y plots, dials, and/or some other type of implementation whether real-world (e.g., physical sliders or dials and the like) or virtual (e.g., in a graphical user interface of an electronic device). For the sake of conciseness, the various options for implementation as described above with respect to the various elements 305/310/320 will not continue to be reiterated with respect to the elements of portion 325.

As may be seen, the instructor selection portion 325 may include a gender element 330. The gender element 330 may allow a user to pick a gender of their virtual instructor. In some embodiments, the gender element 330 may be implemented as a binary selection (e.g., “male” or “female”). In other embodiments, the gender element 330 may allow a user to select gender on a spectrum, for example with female at one end and male at the other, so that a user may have a variety of options to select a preferred voice of an instructor.

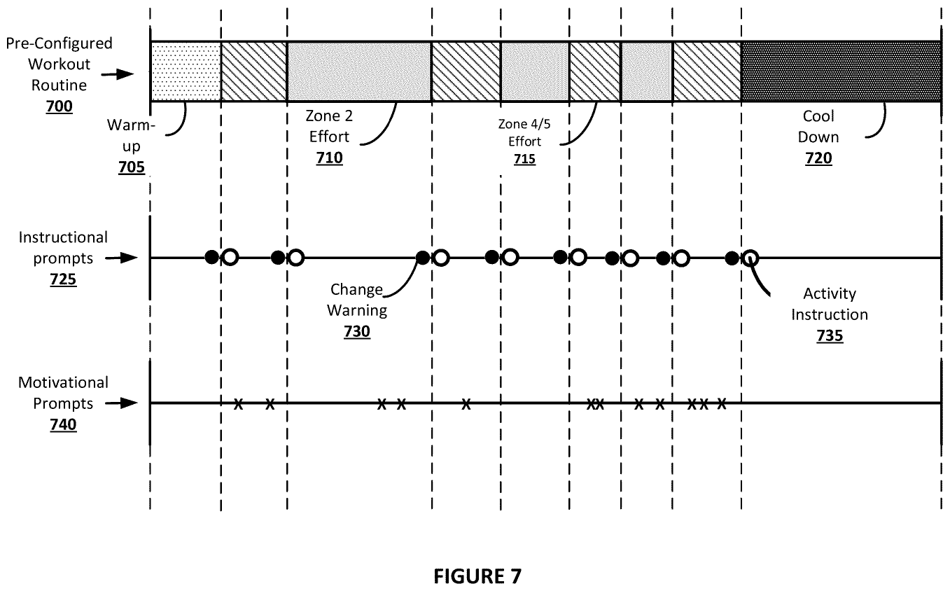

The instructor selection portion 325 may further include a prompt frequency element 335. The prompt frequency element 335 may allow a user to select how often the virtual instructor provides a prompt. In some embodiments, as discussed in greater detail with respect to FIG. 7, various of the prompts such as the instructional prompts may not be affected by the prompt frequency element 335. Rather, the prompt frequency element 335 may only affect motivational prompts. This implementation may be because the instructional prompts are considered necessary for the user to be able to accurately perform the workout routine and, as such, they may not be reduced or increased. In other embodiments, the prompt frequency element 335 may affect both the instructional and motivational prompts. In some embodiments, there may be two prompt frequency elements such that one affects instructional prompts (e.g., allowing a user to increase the number of instructional prompts if they feel a workout routine is too difficult for them to be able to hold all of the instructions at once), and another that affects the motivational prompts.

The instructor selection portion 325 may further include an instructor attitude element 340, which may allow a user to select between different attitudes of an instructor. For example, the user may be provided the option of selecting an enthusiastic instructor, a “laid back” or less-enthusiastic instructor, a stricter “drill sergeant” type instructor, or some other type of attitude.

The instructor selection portion 325 may further include an instructor positivity element 345. This element 345 may allow a user to select, for example, a very positive and supportive instructor, a negative and insulting instructor, a joking/teasing instructor, or some other type of instructor.

The attitude element 340 and the positivity element 345 may be desirable to a user who wishes to have an instructor with a less cheerful or more cheerful attitude for a variety of reasons. For example, a user may find a highly cheerful and enthusiastic instructor to be unpleasant and/or annoying. In some cases, the user may select an instructor with less positive or enthusiastic attributes because they are tired and want a more “laid back” instructor. In some cases, the user may select a negative or teasing instructor because the user finds the instructions to be funny. A variety of other reasons may be present for a user to select from less positiver or less enthusiastic attributes.

In some embodiments, the instructor selection portion 325 may further include a difficulty correlation element 350. The difficulty correlation element 350 may dynamically change one or more of the previously described elements such as elements 335, 340, or 345 based on the difficulty of a specific exercise or set of exercises in a workout routine. For example, the difficulty correlation element 350 may increase the frequency of motivational prompts, the positivity of an instructor, and/or the enthusiasm in an instructor's attitude. Element 350 may allow a user to select the degree to which the various other elements 335/340/345 are affected.

The instructor selection portion 325 may further include a frequency randomizer element 355, an attitude randomizer element 360, and a positivity randomizer element 365. The various elements 355/360/365 may allow a user to select a range of settings, rather than a single setting, for elements 335, 340, and 345, respectively. In this way, the user may be able to provide a degree of variance to the prompts of the virtual instructor, which may allow the instructor's prompts, attitude, and/or positivity settings to avoid becoming repetitive or “stale” to the user.

It will be understood that the specific elements depicted in FIG. 3 are intended as examples related to characteristics of a virtual instructor, but other elements may be present in other embodiments. For example, additional elements related to an. Instructor's humour level, an instructor's accent, an instructor's age, etc. may additionally or alternatively be present. However, such additional elements are not depicted for the sake of lack of redundancy of the Figure.

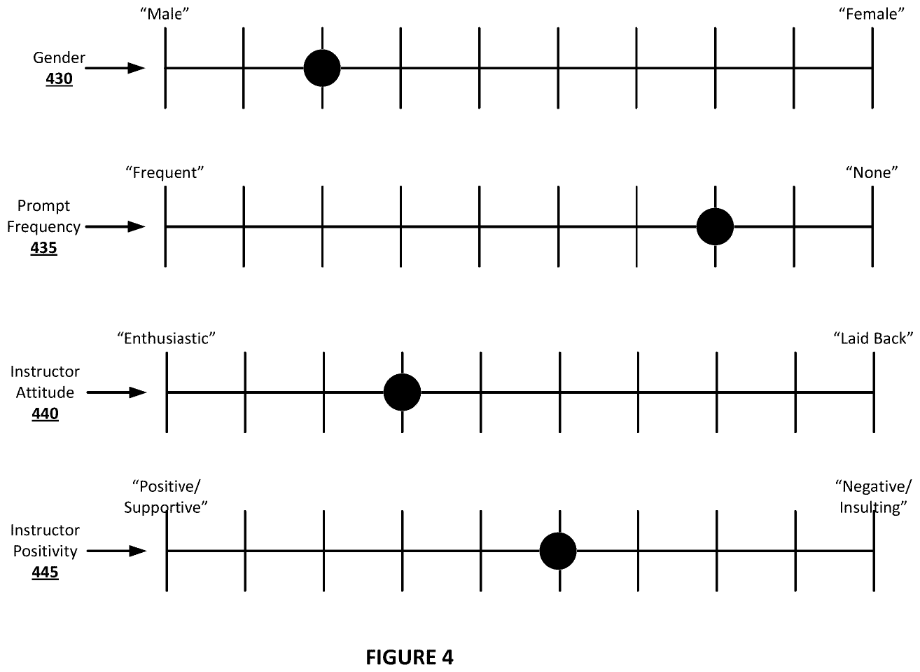

FIG. 4 depicts an example of elements of a user interface, in accordance with various embodiments. It will be understood that the various depicted elements are shown as a slider with discrete positions, however in other embodiments one or more of the various depicted elements may be implemented as a different type of slider, a dial, a drop-down menu, a text box, check boxes, and/or some other user-selectable element. It will also be understood that other embodiments may include various elements with more or fewer discrete positions, binary choices, elements with non-discrete positions, etc.

It will also be understood that the various elements depicted in FIG. 4 show a range between two depicted opposing concepts such as “frequent” and “none,” “enthusiastic” and “laid back,” etc. It will be understood that these particular concepts for each element are provided as examples of two different concepts that may relate to the general concept of the depicted element. However, in other embodiments, one or more of the depicted elements may use one or more different words or concepts. In some embodiments, a specific word or concept (e.g., “frequent” or “none”) may not even be presented, and the slider may depict another designation such as numerals, or no designation at all.

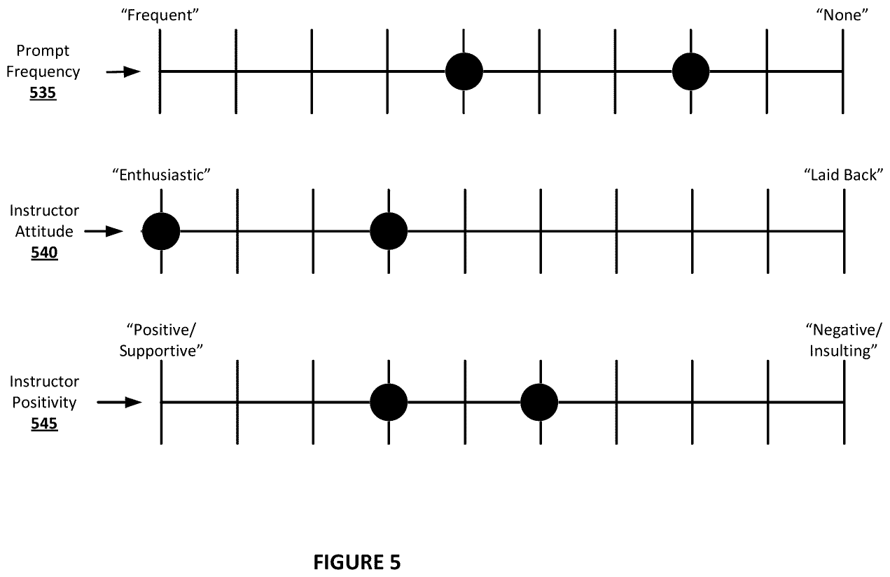

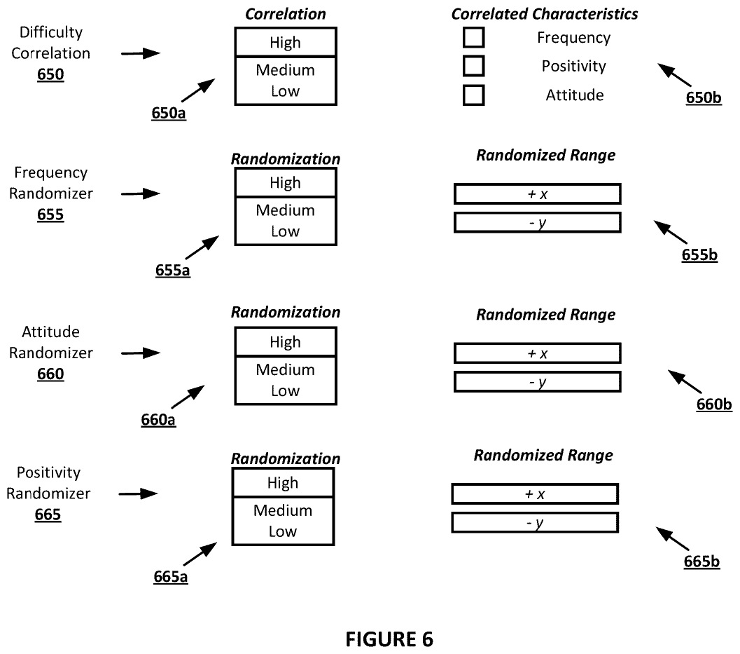

More generally, it will be understood that the specific implementations shown in FIG. 4 (and likewise in FIG. 5 or 6) are intended as non-limiting examples for the purpose of illustration and discussion, but are not intended to limit the various depicted elements to a specific configuration or word-selection. Other embodiments may use different configurations or word selections based on, for example, user preference, user language, market testing, or some other criteria.

FIG. 4 depicts a gender selection element 430, which may be similar to, and share one or more characteristics with, element 330 described above. In the implementation depicted in FIG. 4, element 430 provides a choice between a “male”-seeming virtual instructor and a “female”-seeming virtual instructor. Changing the element 430 may, for example, change the pitch and/or tonality of the voice of the virtual instructor between a lower-pitched and more stereotypically “male” voice, or a higher-pitch more stereotypically “female” voice.

FIG. 4 also depicts and prompt frequency element 435, which may be similar to, and share one or more characteristics with, element 335. In the implementation of FIG. 4, the prompt frequency element 435 provides a user to choose between “frequent” prompts or no prompts (depicted as “none”). By selecting “none,” then the virtual instructor may not provide any motivational prompts, but rather only be limited to instructional prompts. By contrast, selecting “frequent” may cause the virtual instructor to provide more often motivational prompts.

FIG. 4 also depicts an instructor attitude element 440, which may be similar to, and share one or more characteristics with, element 340. The instructor attitude element 440 may allow a user to select a setting along a spectrum between “enthusiastic” and “laid back.” More generally, the instructor attitude element 440 may allow the user to select the degree of enthusiasm or intensity with which the motivational and/or instructional prompts are provided by the virtual instructor.

FIG. 4 also depicts an instructor positivity element 445, which may be similar to, and share one or more characteristics with, instructor positivity element 345. The instructor positivity element 445 may allow a user to select a positivity level of the instructor from two or more options. In the embodiment of FIG. 4, the instructor positivity element depicts a spectrum between “positive/supportive” and “negative/insulting.”

FIG. 5 depicts an alternative example of elements of a user interface, in accordance with various embodiments. Similarly to FIG. 4, it will be understood that the specific depiction of the various elements in FIG. 5 are intended as one non-limiting example for the sake of discussion only.

Generally, the elements depicted in FIG. 5 are depicted showing a user-selected range. By providing a range, rather than a singular value, a user may be enabled to introduce a degree of variety to various elements of the virtual instructor.

As an example, FIG. 5 depicts prompt frequency element 535, which may be similar to, and share one or more characteristics with, elements 335/435. As shown the prompt frequency element 535 may allow selection of a range of values. By selecting the range, the user may be enabled to have changing prompt frequency, which may introduce a degree of randomness to the prompts and make them more “human” feeling to the user. Selection of a range of values for the prompt frequency element 535 may additionally/alternatively have other effects for the user.

As another example, FIG. 5 depicts instructor attitude element 540, which may be similar to, and share one or more characteristics with, elements 340/440. By selecting a range of values as shown in FIG. 5, the attitude of the virtual instructor may have some degree of randomness, which may likewise have a more natural feel for the user.

As another example, FIG. 5 depicts instructor positivity element 545, which may be similar to, and share one or more characteristics with, elements 345/445. Similarly to element 540, by selecting a range of values for the instructor positivity element 545, rather than a single element, the positivity level of the virtual instructor may have a degree of randomness which may further enable a more natural feel for the user.

FIG. 6 depicts an alternative example of elements of a user interface, in accordance with various embodiments. The example elements of FIG. 6 may be used in conjunction with, for example, the example elements of FIGS. 4 and/or 5. As a specific example, the elements of FIGS. 4, 5, and/or 6 may be shown to a user either concurrently, sequentially, or in some other combination or subset in the instructor selection portion 325 of the user interface 315.

As an example, FIG. 6 depicts difficulty correlation element 650, which may be similar to, and share one or more characteristics with, difficulty correlation element 350. The difficulty correlation element 650 may include a correlation factor 650a, which is depicted in FIG. 6 as providing a selection between “high,” “medium,” and “low.” In other embodiments, these options may be implemented as numeric choices, implemented in a drop down menu, and/or implemented in some other manner.

The difficulty correlation element 650 may additionally include a correlated characteristics element 650b. The correlated characteristics element 650b may allow a user to select which of the various virtual instructor characteristics may be affected by the difficulty correlation as previously described with respect to element 350. For example, as shown in FIG. 6, a user may be able to select (e.g., by checking the provided boxes), which of frequency (i.e., prompt frequency), positivity (i.e., instructor positivity), and attitude (i.e., instructor attitude) the user wishes to be correlated to difficulty of the portion(s), exercise(s), or set(s) of exercise that are currently being provided by the workout routine.

FIG. 6 also depicts a frequency randomizer element 655, which may be similar to, and share one or more characteristics with, frequency randomizer element 355. Specifically, the frequency randomizer element 355 may allow a user to select a degree of randomization to the frequency with which prompts (e.g., motivational prompts) are provided to a user as previously described.

The frequency randomizer element 655 may include a degree of randomization element 655a, which is depicted as providing a selection between “high,” “medium,” and “low.” In other embodiments, these options may be implemented as numeric choices, implemented in a drop down menu, and/or implemented in some other manner.

The frequency randomizer element 655 may additionally or alternatively include a range element 655b, which is depicted as providing a user a selection of a range between value-y and +x. By providing a range that allows a range between negative and positive values, a user may be able to select both a degree of less frequency and a degree of more frequency, which may allow the user a greater degree of customization. In other embodiments, the range 655b may be a single value, e.g., z, which may allow a user to select a range between 0 and z. In other embodiments, the range may be implemented according to some other variation. In some embodiments, the range element 655b may not be necessary if element 655a is presented, and vice-versa.

FIG. 6 also depicts an attitude randomizer element 660, which may be similar to, and share one or more characteristics with, attitude randomizer element 360. Specifically, the attitude randomizer element 660 may allow a user to select a degree of randomization to the attitude of the virtual instructor as previously described. The attitude randomizer element 660 may include a degree of randomization element 660a and/or a range element 660b. Elements 660a and 660b may be similar to, and share one or more characteristics with, elements 655a and 655b, and will not be described in further detail herein for the sake of lack of redundancy.

FIG. 6 also depicts a positivity randomizer element 665, which may be similar to, and share one or more characteristics with, positivity randomizer element 365. Specifically, the positivity randomizer element 665 may allow a user to select a degree of randomization to the positivity of the virtual instructor as previously described. The positivity randomizer element 665 may include a degree of randomization element 665a and/or a range element 665b. Elements 665a and 665b may be similar to, and share one or more characteristics with, element 655a and 655b, and will not be described in further detail herein for the sake of lack of redundancy.

As has been noted at various points herein, the specific shape or type of an element (e.g., a slider, a dial, a drop-down, etc.), the wording of an element (e.g., the specific word used to represent an element), the location of an element, the inclusion of an element, etc. is presented herein as an example of one embodiment for the sake of discussion only. In other embodiments, various of the elements may be implemented in a different manner, with different wording, etc. Different ones of the elements may be combined, split into multiple elements, excluded, etc. In other embodiments, various additional elements or concepts related to the personality, enthusiasm, frequency of prompts, etc. of a virtual instructor may be present. Similarly, the specific configuration of a user interface such as user interface 315 may be different in different embodiments.

Generally, as previously noted and has been described herein, embodiments relate to allowing a user to tailor various characteristics of a virtual instructor to their personal preferences. Such characteristics may include characteristics such as the age, gender, or accent of the prompts provided by the virtual instructor. Other characteristics may relate to the level of positivity and/or enthusiasm of the virtual instructor, the frequency with which the virtual instructor provides prompts such as motivational and/or instructional prompts, the types of words or phrases (e.g., mocking, humorous, supportive, etc.), etc. In some specific embodiments, the frequency settings may only affect motivational prompts, and the frequency of the instructional prompts may not be changeable by the user. In some embodiments, an element may relate to or include a repetition setting which may affect whether instructional prompts are repeated (e.g., before and after the beginning of a specific exercise or set of exercises) or only presented o a user a single time. It will be understood that the characteristics described herein are presented solely for the sake of non-limiting example, and other embodiments may have other variations beyond what is explicitly described or discussed herein.

FIG. 7 depicts an example of different user experiences with a virtual instructor, in accordance with various embodiments. Specifically, FIG. 7 depicts an example pre-configured workout routine 700. It will be understood that, similarly to the workout routines depicted in FIG. 2, the pre-configured workout routine 700 is intended solely for the sake of description and discussion. It will also be understood that each and every element in FIG. 7 is not labelled for the sake of lack of clutter and redundancy in the Figure. Generally, the X-axis or lateral axis of FIG. 7 represents the time domain, and the workout routine progresses from left to right (as oriented in FIG. 7).

As may be seen in FIG. 7, the pre-configured workout routine 700 may include a warm-up portion 705. The pre-configured workout routine 700 may additionally include four Zone 4/5 effort portions 715 of varying lengths. The pre-configured workout routine 700 may additionally include three Zone 2 effort portions 710 of varying lengths. Finally, the pre-configured workout routine 700 may include a cool down portion 720 as shown.

As noted, the various portions of the pre-configured workout routine 700 may be pre-configured, and information regarding the types of exercises, the timing of different exercises/portions/sets/etc., the intensity of the different exercises/portions/sets/etc., and/or other information related to the pre-configured workout routine 700 may have been previously generated and stored. For example, the information may be stored in one or more databases such as workout database 135. In other embodiments, the information may be stored in one or more databases that are either local to or remote from one or both of the workout system 120, the user input interface 125, and/or outputs such as the audio output 105 and/or video output 110 as described with respect to FIG. 1. As such, when a user selects a specific pre-configured workout routine, then the information related to the workout routine may be retrieved from the storage (e.g., the workout database) by logic such as prompt generation logic 130.

The prompt generation logic 130 may then generate one or more prompts related to the workout routine as shown in FIG. 7 and as previously described. Such prompts may be generated based on the information related to the workout routine that was retrieved from workout database 135 and information from a database such as user preference database 125.

One set of prompts may be the instructional prompts 725. The instructional prompts 725 may include an instructional prompt related to warning a user of a change in the workout routine at 730. These prompts may generally occur prior to the change from one exercise/set/portion/etc. to another. Such prompts may, for example, tell a user that a change is upcoming and give information regarding the change. A simplistic example may be “in 15 seconds we will change from Zone 2 to Zone 4/5.” This way, a user may be able to prepare themselves for a change in the workout routine, for example by changing gears. Other examples may relate to other changes such as a change in seating position, a change in tempo, a change in stroke, a change in running style, a change in yoga positions, etc.

Another type of instructional prompts may be instructional prompts related to activity instruction 735. The activity instruction prompts 735 may occur subsequent to a change in exercise/set/portion/etc. The activity instruction prompts 735 may provide the user with more detailed instruction regarding a given exercise/set/portion/etc. Such detailed instruction may include instruction regarding specific form, reminders regarding breathing, reminders regarding the number of repetitions of a given exercise, and/or some other activity instruction.

As previously noted, in some embodiments the instructional prompts may be affected by various ones of the elements of the user interface 315, and not affected by others of the elements of the user interface 315. For example, the instructional prompts 725 may be affected by elements related to gender, attitude, positivity, age, accent, etc. of the virtual instructor. For example, if a positive and enthusiastic instructor was selected, then a change warning prompt 730 may say “Alright! Almost there and then we'll change to Zone 2 effort to relax! You've got this!” By contrast, a negative and strict instructor may forcefully say “In a minute you get a break at Zone 2. Don't you dare start slacking!” A positive and “laid-back” type instructor may say in calmer tones, “In a minute, we're going into Zone 2.”

However, in some embodiments the instructional prompts 725 may be affected by user selected characteristics of the virtual instruction such as frequency. For example, in one embodiment selection of frequency may affect how often certain ones of the instructional prompts (e.g., the change warning 730 and/or the activity instruction 735) are provided to the user. In some embodiments, the user may be familiar with the workout routine, and so wish to de-active one or both of the instructional prompts and instead rely on memory, music changes, a written prompt, or some other source.

Another type of prompts is motivational prompts 740. As previously described, the motivational prompts 740 may relate to prompts that are not intended to provide specific instruction to a user, but rather are intended to provide motivation to the user. Such prompts may include phrases such as “you can do it,” or “just a little more.” However, as noted, various ones of the motivational prompts may be presented to the user according to one or more of the user preferences retrieved from the user preference database 125. As a specific example, if a user chose to have a demotivating or insulting instructor (e.g., via element 345), then instead of a positive and supportive prompt, the virtual instructor may tell the user “you'll never make it.” In some embodiments, the user may control a degree of humour of the instructor such that an instructor may instead say “My 92 year old grandmother could outrun you,” In some embodiments, a user may select a positive instructor that is less than enthusiastic, and so the virtual instructor may say “Not bad, man.” Various other characteristics may be selected to change the presentation of one or more of the motivational prompts 740 as described herein.

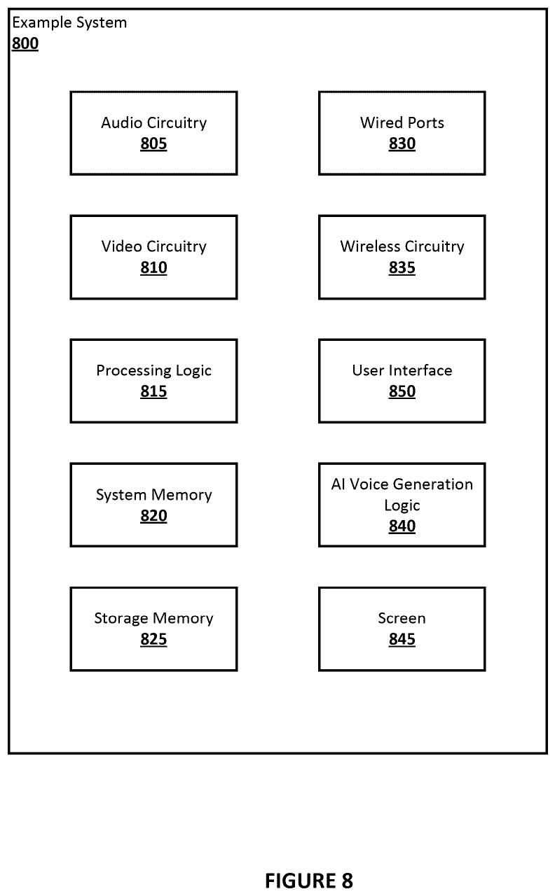

FIG. 8 depicts an example system 800 which may be used to implement at least a portion of a workout app, in accordance with various embodiments. Generally, system 800 may be similar to, and share one or more characteristics or elements with, system 100. In some embodiments, the system 800, or portions thereof, may be implemented as an electronic computing device such as a cellular phone, a watch, a tablet, a personal digital assistant, a laptop or desktop computer, and/or some other type of electronic device or system.

The system 800 may have an audio circuitry 805, which may be similar to audio output 105. The audio circuitry 805 may be, for example one or more speakers, a directly-wired set of headphones or some other type of earbud or over-ear headphone, a port to couple a set of headphones/earbud/speaker, etc. In some embodiments, the audio circuitry 805 may include or be a part of circuitry that facilitates audio output from a wirelessly coupled audio device such as a set of wirelessly connected earbuds or headphones.

The system 800 may also have a video circuitry 810, which may be similar to video output 110. The video circuitry 810 may facilitate the presentation of one or more images to a user (e.g., such as an image of a virtual instructor). In some embodiments, the video output may be or implement a screen on the device itself (e.g., screen 845), a port to couple to an external video device, logic to facilitate video output from a wirelessly coupled video device, etc.

The system 800 may also have processing logic 815. The processing logic 815 may include one or more processors, processor cores, CPUs, etc. In some embodiments the processing logic 815 may be implemented as hardware, software, firmware, and/or some combination thereof. In some embodiments, the processing logic 815 may be, include, and/or be part of logic of the workout system 120 such as the prompt generation logic 130. In some embodiments, at least a portion of the processing logic 815 may be implemented remote from the system 800 (e.g., via “the Cloud”). In some embodiments, the processing logic 815 may further control various functions of the system 800 such as elements of the system 800 that are unrelated to a workout app (e.g., power control, startup or startdown sequences, other apps, etc.).

The system 800 may further include system memory 820. The system memory 820 may be, include, or be part of memory such as volatile or non-volatile memory, solid state memory, flash memory, ROM, RAM, etc. Generally, the system memory 820 may be used for system-related functions such as startup/startdown sequences, power control, other apps, etc.

The system 800 may further include storage memory 825, which may be similar to, and share one or more characteristics with, the user preference database 125 and/or the workout database 135. In some embodiments the system memory 820 and the storage memory 825 may be the same memory or type of memory (e.g., the same physical block of memory on a circuit board of the system 800). In other embodiments, the system memory 820 and the storage memory 825 may be physically separate from one another. In some embodiments, at least a portion of the system memory 820 and/or the storage memory 825 may be remote from the system 800 (e.g., in “the Cloud”).

The system 800 may further include wired ports 830. The wired ports 830 may include ports that allow for the coupling of a wired audio device (e.g., speakers, headphones, earbuds, etc.), a wired video device (e.g., a projector, a monitor, a television screen, etc)), a power supply, a peripheral device, and/or some other type of wired device to the system 800. In some embodiments, the wired ports 830 and the audio circuitry 805 (and/or the video circuitry 810) may be the same port, and in some embodiments the various ports/outputs/circuitry may be different from one another. In some embodiment, the wired ports 830 may allow the system 800 to couple with a power supply to provide power to the system 800 and/or a battery of the system 800 (not shown in FIG. 8 for the sake of reduction of clutter).

The system 800 may further include wireless circuitry 835. The wireless circuitry 835 may allow for wireless coupling with an audio and/or video device that is remote from the system 800. For example, the wireless circuitry 835 may allow for coupling via a wireless local area network (WLAN), Wi-Fi™, a cellular connection such as third generation partnership project (3GPP)™ 4th/5th/6th/etc. cellular networks, Bluetooth™, and or some other type of wireless protocol. In some embodiments, the wireless circuitry 835 may be, include, or be part of wireless power control circuitry such as inductive charging circuitry that allows power to be supplied to the system 800 and/or a battery of the system 800.

The system 800 may further include AI voice generation logic 840 which may be similar to, and share one or more characteristics with, AI voice generation logic 140 of FIG. 1. In some embodiments, the AI voice generation logic 840 may be, or may be part of, processing logic 815. In other embodiments, the AI voice generation logic 840 may be separate from the processing logic. In some embodiments, the AI voice generation logic 840 may be at least partially implemented remotely from the system 800 (e.g., in “the Cloud”).

The system 800 may further include a user interface 850 and/or a screen 845. The user interface 850 may be, for example, a keyboard, a mouse, and/or some other type of interface by which a user may provide one or more indications or preferences to system 800. The screen 845 may display one or more still or moving images to a user. In some embodiments, the user interface 850 and the screen 845 may at least partially be the same element (e.g., a touchscreen). In some embodiments, one or both of the user interface 850 and the screen 845 may be the same as the video circuitry 810.

It will be understood that the above description of system 800 is intended as a highly simplified example in accordance with one embodiment of such a system 800. Real-world implementations may include more, fewer, or different elements than are depicted in FIG. 8. Various of the elements of FIG. 8 may be combined, split into multiple elements, etc.

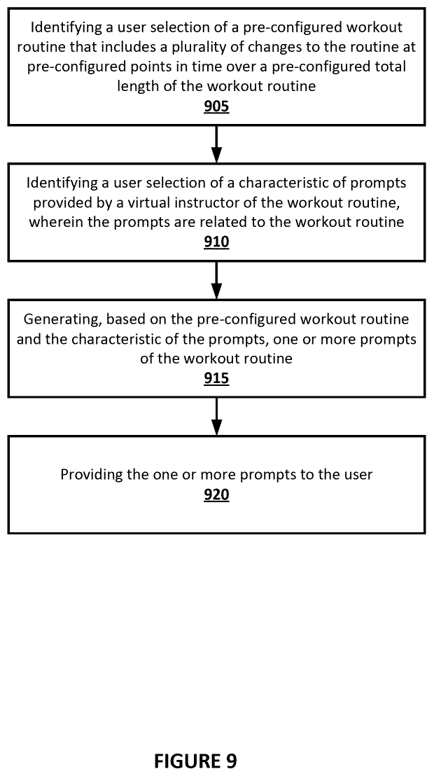

FIG. 9 depicts an example of a process flow related to implementation of a virtual instructor and/or a workout app, in accordance with various embodiments. Generally, the process of FIG. 9 may be at least partially implemented by a system such as systems 100 or 800. More specifically, the process of FIG. 9 and/or elements thereof may be performed by a workout system such as workout system 120, prompt generation logic 130, AI voice generation logic 140, processing logic 815, AI voice generation logic 840, etc.

The process may include identifying, at 905, a user selection (e.g., by a user of the system 100/800) of a pre-configured workout routine that includes a plurality of changes to the pre-configured workout routine at pre-configured points in time over a pre-configured total length of the workout routine. The workout routine may be a pre-configured workout routine that is stored, at least in part, in a workout database such as workout database 135.

The process may further include identifying, at 910, a user selection of a characteristic of prompts provided by a virtual instructor of the workout routine, wherein the prompts are related to the workout routine. For example the user selection may be provided via user input interface 115. In some embodiments, the selection may be previously input by the user and stored in a database such as user preference database 125. The characteristic may relate to various characteristics such as age, gender, accent, positivity, attitude, enthusiasm, humour level, strictness, and/or some other characteristic of the personality or person of the virtual instructor and the prompts they provide during execution of the workout routine. Other characteristics may relate to, a randomization or correlation factor of one or more other characteristics, a frequency of prompts, etc.

The process may further include generating, at 915 based on the pre-configured workout routine and the characteristic of the prompts, one or more prompts of the workout routine. Such prompts may be or include one or more motiviational and/or one or more instructional prompts as previously described.

The process may further include providing, at 920, the one or more prompts to the user. For example, the prompts may be provided to the user via audio output 105, video output 110, and/or some other way of providing information to a user of systems 100 and/or 800.

It will be recognized that the above-described process is one example process. Other embodiments may include processes that have more, fewer, or different elements, elements arranged in a different order, elements that occur concurrently with one another, etc.

In the preceding description, various aspects of the illustrative implementations were described using terms commonly employed by those skilled in the art to convey the substance of their work to others skilled in the art. However, it will be apparent to those skilled in the art that embodiments of the present disclosure may be practiced with only some of the described aspects. For purposes of explanation, specific numbers, materials, and configurations were set forth in order to provide a thorough understanding of the illustrative implementations. It will be apparent to one skilled in the art that embodiments of the present disclosure may be practiced without the specific details. In other instances, well-known features have been omitted or simplified in order not to obscure the illustrative implementations.

In the preceding detailed description, reference is made to the accompanying drawings that form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the detailed description is not to be taken in a limiting sense.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). More generally, various embodiments may include any suitable combination of the above-described embodiments including alternative (or) embodiments of embodiments that are described in conjunctive form (and) above (e.g., the “and” may be “and/or”). Furthermore, some embodiments may include one or more articles of manufacture (e.g., non-transitory computer-readable media) having instructions, stored thereon, that when executed result in actions of any of the above-described embodiments. Moreover, some embodiments may include apparatuses or systems having any suitable means for carrying out the various operations of the above-described embodiments.

The description may have used perspective-based descriptions such as top/bottom, in/out, over/under, and the like. Such descriptions were used to facilitate the discussion and were not intended to restrict the application of embodiments described herein to any particular orientation.

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. The term “directly coupled” may mean that two or more elements are in direct contact.

As used herein, the term “module” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable components that provide the described functionality.

These modifications may be made to the embodiments in light of the above detailed description. The terms used in the following claims should not be construed to limit the embodiments to the specific implementations disclosed in the specification and the claims.

### EXAMPLES

Some non-limiting examples of various embodiments may be as follows:

Example 1 includes a method to be performed by an electronic device, wherein the method comprises: identifying a user selection of a pre-configured workout routine that includes a plurality of changes to the routine at pre-configured points in time over a pre-configured total length of the workout routine; identifying a user selection of a characteristic of prompts provided by a virtual instructor of the workout routine, wherein the prompts are related to the workout routine; generating, based on the pre-configured workout routine and the characteristic of the prompts, one or more prompts of the workout routine; and providing the one or more prompts to the user.

Example 2 includes the method of example 1, and/or some other example herein, wherein the one or more prompts include an instructional prompt that provides functional instruction to a user regarding the workout routine.

Example 3 includes the method of any one or more of examples 1-2, and/or some other example herein, wherein the one or more prompts include a motivational prompt that includes non-functional comments related to the workout routine.

Example 4 includes the method of example 3, and/or some other example herein, wherein the characteristic relates to a frequency of generation of motivational prompts.

Example 5 includes the method of any one or more of examples 1-4, and/or some other example herein, wherein the one or more prompts are based at least in part on artificial intelligence (AI) logic.

Example 6 includes the method of any one or more of examples 1-5, and/or some other example herein, wherein the characteristic relates to a gender of the virtual instructor.

Example 7 includes the method of any one or more of examples 1-6, and/or some other example herein, wherein the characteristic relates to an accent of the virtual instructor.

Example 8 includes the method of any one or more of examples 1-7, and/or some other example herein, wherein the characteristic relates to an age of the virtual instructor.

Example 9 includes the method of any one or more of examples 1-8, and/or some other example herein, wherein the characteristic relates to a level of positivity of the virtual instructor.

Example 10 includes the method of any one or more of examples 1-9, and/or some other example herein, wherein the characteristic relates to an attitude of the instructor.

Example 11 includes the method of any one or more of examples 1-10, and/or some other example herein, wherein the characteristic relates to a randomization value of another user-selected characteristic of the virtual instructor.

Example 12 includes the method of any one or more of examples 1-11, and/or some other example herein, wherein the characteristic relates to a correlation factor of another user-selected characteristic of the virtual instructor to a difficulty of a portion of the workout routine.

Example Z01 may include an apparatus comprising means to perform one or more elements of the method described in or related to any one or more of examples 1-12, and/or any other method, process, or technique process described herein, or portions or parts thereof.

Example Z02 may include an apparatus comprising logic, modules, or circuitry to perform one or more elements of the method described in or related to any one or more of examples 1-12, and/or any other method, process, or technique described herein, or portions or parts thereof.

Example Z03 may include a method, technique, or process as described in or related to any one or more of examples 1-12, and/or any other method, process, or technique described herein, or portions or parts thereof.

Example Z04 may include a signal as described in or related to any one or more examples 1-12, and/or any other method, process, or technique described herein, or portions or parts thereof.

Example Z05 may include an apparatus comprising one or more processors and non-transitory computer-readable media that include instructions which, when executed by the one or more processors, are to cause the apparatus to perform one or more elements of the method described in or related to any one or more of examples 1-12, and/or any other method, process, or technique described herein, or portions or parts thereof.

Example Z06 may include one or more non-transitory computer readable media comprising instructions that, upon execution of the instructions by one or more processors of an electronic device, are to cause the electronic device to perform one or more elements of the method described in or related to any one or more of examples 1-12, and/or any other method, process, or technique described herein, or portions or parts thereof.

Example Z07 may include a computer program related to one or more elements of the method described in or related to any one or more of examples 1-12, and/or any other method, process, or technique described herein, or portions or parts thereof.

1. One or more non-transitory computer-readable media comprising instructions that, upon execution of the instructions by logic of an electronic device, are to cause the logic to:
identify a user selection of a pre-configured workout routine that includes a plurality of changes to the pre-configured workout routine at pre-identified points in time over a pre-identified total length of the workout routine;
identify a user selection of a characteristic of prompts provided by a virtual instructor of the workout routine, wherein the prompts are related to the workout routine;
generate, based on the pre-configured workout routine and the characteristic of the prompts, one or more prompts of the workout routine; and
provide the one or more prompts to the user.

2. The one or more non-transitory computer-readable media of claim 1, wherein the one or more prompts include an instructional prompt that provides functional instruction to a user regarding the workout routine.

3. The one or more non-transitory computer-readable media of claim 1, wherein the one or more prompts include a motivational prompt that includes non-functional comments related to the workout routine.

4. The one or more non-transitory computer-readable media of claim 3, wherein the characteristic relates to a frequency of generation of motivational prompts.

5. The one or more non-transitory computer-readable media of claim 1, wherein generation of the one or more prompts is based at least in part on artificial intelligence (AI) logic.

6. The one or more non-transitory computer-readable media of claim 1, wherein the characteristic relates to a gender of the virtual instructor.

7. The one or more non-transitory computer-readable media of claim 1, wherein the characteristic relates to an accent of the virtual instructor.

8. The one or more non-transitory computer-readable media of claim 1, wherein the characteristic relates to an age of the virtual instructor.

9. The one or more non-transitory computer-readable media of claim 1, wherein the characteristic relates to a level of positivity of the virtual instructor.

10. The one or more non-transitory computer-readable media of claim 1, wherein the characteristic relates to an attitude of the virtual instructor.

11. The one or more non-transitory computer-readable media of claim 1, wherein the characteristic relates to a randomization value of another user-selected characteristic of the virtual instructor.

12. The one or more non-transitory computer-readable media of claim 1, wherein the characteristic relates to a correlation factor of another user-selected characteristic of the virtual instructor to a difficulty of a portion of the workout routine.

13. An electronic device comprising:
memory to store information related to a plurality of pre-configured workout routines, wherein respective workout routines of the plurality of pre-configured workout routines have a plurality of changes to the workout routine at pre-configured points in time over a pre-configured total length of the workout routine; and
one or more processors configured to:
identify a user selection of a pre-configured workout routine from the plurality of pre-configured workout routines;
identify a user selection of a characteristic of prompts provided by a virtual instructor of the workout routine, wherein the prompts are related to the workout routine;
generate, based on the pre-configured workout routine and the characteristic of the prompts, one or more prompts of the workout routine; and
provide the one or more prompts to the user.

14. The electronic device of claim 13, wherein the one or more prompts include an instructional prompt that provides functional instruction to a user regarding the workout routine.

15. The electronic device of claim 13, wherein the one or more prompts include a motivational prompt that includes non-functional comments related to the workout routine.

16. The electronic device of claim 13, wherein generation of the one or more prompts is based at least in part on artificial intelligence (AI) logic.

17. A workout system comprising:
a workout database configured to store an indication of a user selection of a pre-configured workout routine from a plurality of pre-configured workout routines;
a user preference database configured to store an indication of a user selection of a characteristic of prompts provided by a virtual instructor of the workout routine, wherein the prompts are related to the workout routine; and
prompt generation logic configured to generate, based on the pre-configured workout routine and the characteristic of the prompts, one or more prompts of the workout routine.

18. The workout system of claim 17, wherein the one or more prompts include an instructional prompt that provides functional instruction to a user regarding the workout routine.

19. The workout system of claim 17, wherein the one or more prompts include a motivational prompt that includes non-functional comments related to the workout routine.

20. The workout system of claim 17, wherein the prompt generation logic is artificial intelligence (AI) logic.
